(19) United States
(12) Patent Application Publication
(10) Pub. No.: US 2012/0154166 A1
(43) Pub. Date: Jun. 21, 2012

(54) STORAGE DEVICE AND METHOD FOR EASY IDENTIFICATION

(75) Inventors: XIANG YU, Shenzhen City (CN); MENG LIU, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD, Shenzhen City (CN)

(21) Appl. No.: 12/980,335

(22) Filed: Dec. 29, 2010

(30) Foreign Application Priority Data
Dec. 16, 2010 (CN) 201010592382.3

(51) Int. Cl. G09F 9/33; G08B 5/36

(52) U.S. Cl. 340/815.45; 340/815.66

(57) ABSTRACT

A method for easily identifying a flash memory card and the flash memory card are disclosed. The flash memory card includes a storage cell, a controlling unit and an indicator. As the flash memory card is connected to a computer, the computer produces a color signal to the flash memory card. The computer shows an icon of the flash memory card with a color corresponding to the signal. The controlling unit of the flash memory card receives the signal and drives the indicator to emit light with the same color as that of the icon of the flash memory card.

### BACKGROUND

1. Technical Field

The present disclosure relates to a storage device and a method for easy identification, and more particularly, to a storage device having an indicator which can be easily identified.

2. Description of Related Art

Flash memory cards are widely used in people's daily life to store data or transfer data from one place to another. A flash memory card can be assigned a name by a user beforehand so that the flash memory card can be recognized by the name by a computer as soon as the flash memory card is connected to the computer. However, if the flash memory card is not given a name by the user beforehand, as the flash memory card is connected with the computer, a name would be automatically assigned to the flash memory card by the computer, such as “DISK1”, “DISK2” or the like. If two or more flash memory cards without being particularly named by the user are simultaneously connected to the computer, the user will be confused and cannot easily tell which name is for which flash memory card.

What is needed, therefore, is a storage device and a method for easy identification which can overcome the limitations described above.

### BRIEF DESCRIPTION OF THE DRAWINGS

Many aspects of the present disclosure can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 schematically shows a structure of a flash memory card of the present disclosure, according to an embodiment.

FIG. 2 is a flowchart showing a method, according to an embodiment, for the flash memory card of FIG. 1 connected to a computer.

FIG. 3 is a schematic view showing an interface displayed by the computer being connected with the flash memory card of FIG. 1.

### DETAILED DESCRIPTION

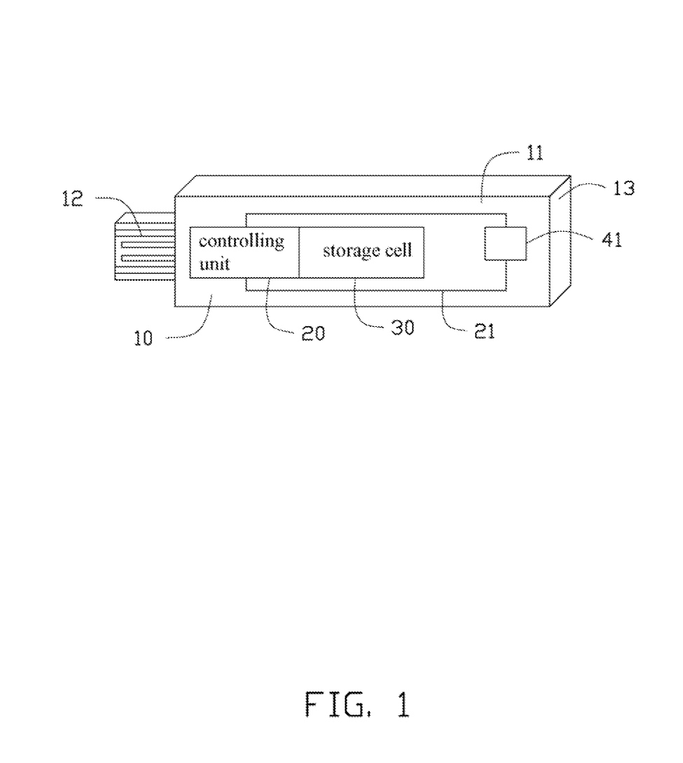

Referring to FIG. 1, a flash memory card of the present disclosure is disclosed. The flash memory card includes a shell 10, a plug 12 extending from a side of the shell 10, a storage cell 30 received in the shell 10, a controlling unit 20 connected to the storage cell 30 and an indicator 41 connected to the controlling unit 20.

The shell 10 may be made from plastic, metal or other suitable materials. The shell 10 is rectangular and has two opposite faces 11 and four lateral faces 13 connected between the two opposite faces 11. The shell 10 has an opening (not shown) defined in one lateral face 13 thereof for extending the plug 12 out of the shell 10. The plug 12 can be inserted into corresponding ports (such as Universal Serial Bus) of a computer to connect the flash memory card to the computer. The storage cell 30 is used for storing data input into the flash memory card. The indictor 41 may be an LED or other suitable light sources which can emit light with various different colors. The indicator 41 extends though one of the two opposite sides 11 of the shell 10 to be exposed out of the shell 10 so that the indicator 41 is visible from an outside of the shell 10. The controlling unit 20 is connected to the indictor 41 via a circuit 21. The controlling unit 20 can change the color of the light emitted from the indicator 41 in response to a signal delivered to the flash memory card.

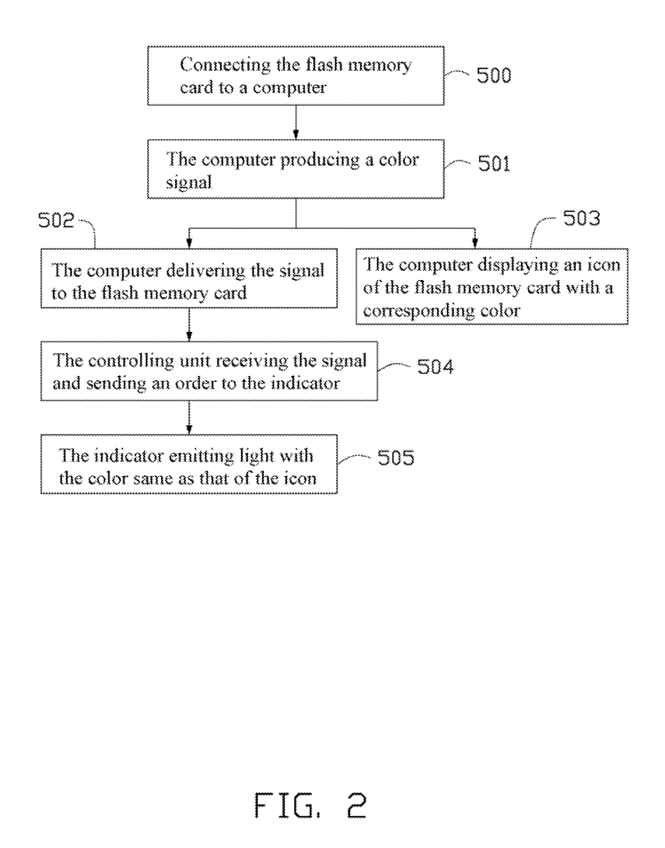

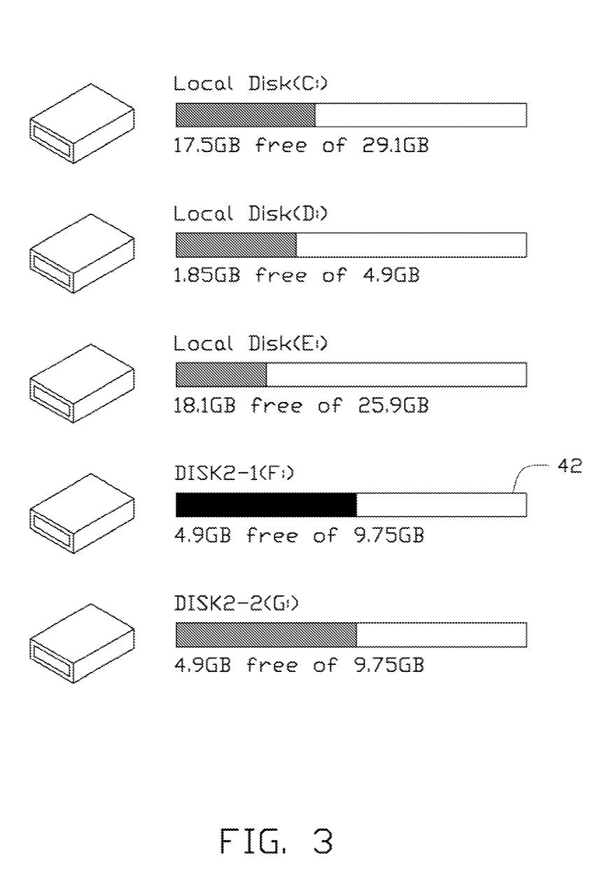

Also referring to FIGS. 2-3, working flows between the flash memory card and a computer includes several steps of 500 to 505. In step 500, the flash memory card is connected to the computer; the computer then producing a color signal in step 501, and accordingly displaying an icon 42 of the flash memory card with a corresponding color in step 503; in steps 502, 504 and 505 the computer also delivering this signal to the flash memory card; the controlling unit 20 receives the signal and controls the indictor 41 to emit light with the same color as that of the icon 42 by the controlling unit 20. Therefore, a user can easily identify the flash memory card from other storage devices due to the same color of the indicator 41 and the icon 42 of the flash memory card displayed on the computer.

It is understood, the flash memory card is used as an example in the embodiment of the present disclosure; however, other storage devices, such as hard disk driver, digital music player, mobile phone, memory stick, are also suitable for the present disclosure.

It is believed that the present disclosure and its advantages will be understood from the foregoing description, and it will be apparent that various changes may be made thereto without departing from the spirit and scope of the present disclosure or sacrificing all of its material advantages, the examples hereinbefore described merely being preferred or exemplary embodiments.

What is claimed is:

1. A method for identifying a storage device, comprising steps of:
providing a storage device, the storage device comprising a storage cell, a controlling unit and an indicator, the indicator being able to emit light with different colors;
connecting the storage device with a computer, the computer producing a color signal and showing an icon of the storage device with a color;
sending the color signal by the computer to the storage device; and
controlling the indicator to emit light of the same color of the icon of the storage device by the controlling unit upon receiving the color signal.

2. The method of claim 1, wherein the storage device is a flash memory card.

3. The method of claim 1, wherein the storage device comprises a shell and a plug extending from a side of the shell.

4. The method of claim 3, wherein the indicator is visible from an outside of the shell.

5. The method of claim 1, wherein the indicator is an LED.

6. The method of claim 1, wherein the controlling unit is connected to the storage cell.

7. A storage device for connecting with a computer, comprising:
a storage cell;
a controlling unit; and
an indicator, the indicator being controllable by the controlling unit to emit light with different colors;
wherein when the storage device is connected with the computer, the computer produces a color signal to the storage device and display an icon of the storage device with a corresponding color, and the controlling unit receives the color signal to control the indicator to emit light having the same color of the icon of the storage device displayed by the computer.

8. The storage device of claim 7, wherein the storage device is a flash memory card.

9. The storage device of claim 7, wherein the indicator is an LED.

10. The storage device of claim 7, wherein the storage cell is connected to the controlling unit.

11. The storage device of claim 7, wherein the indicator is connected to the controlling unit via a circuit.
